(19) United States
(12) Patent Application Publication
(10) Pub. No.: US 2016/0132287 A1
(43) Pub. Date: May 12, 2016

(54) Dynamic Reconfiguration of Audio Devices

(71) Applicant: Microsoft Technology Licensing, LLC, Redmond, WA (US)

(72) Inventors: Kishore Kotteri, Bothell, WA (US); Frank Yerrace, Woodinville, WA (US); Robert Heitkamp, Sammamish, WA (US)

(73) Assignee: Microsoft Technology Licensing, LLC, Redmond, WA (US)

(21) Appl. No.: 14/939,313

(22) Filed: Nov. 12, 2015

Related U.S. Application Data
(60) Provisional application No. 62/078,971, filed on Nov. 12, 2014.

(51) Int. Cl. G06F 3/16; G06F 9/445

(52) U.S. Cl. CPC G06F 3/165; G06F 9/44505; G06F 3/162

(57) ABSTRACT

In one example, a shared buffer acting as an audio communication channel for an audio interaction device may be reconfigured to allow audio communication channel sharing between audio data streams. An audio interaction device may execute a conversion between an initial audio data stream and an audio signal audibly detectable by a user. A shared buffer may act as an audio communication channel between an operating system and the audio interaction device. The digital audio system may execute an initial audio application with the operating system to process the initial audio data stream. The digital audio system may load the initial audio data stream into the shared buffer. The digital audio system may alter the audio communication channel into a restructured audio communication channel for a subsequent audio data stream while maintaining the initial audio data stream. The digital audio system may load the initial audio data stream into the restructured audio communication channel.

### PRIORITY INFORMATION

This application claims priority from U.S. Provisional Patent Application Ser. No. 62/078,971, filed Nov. 12, 2014, the contents of which are incorporated herein by reference in its entirety.

### BACKGROUND

A computing device may execute an application that acts as an audio application by processing a digital audio data stream. An operating system may exchange the digital audio data stream with an audio interaction device. An audio interaction device, such as a speaker or microphone, may render a digital audio data stream as an audio signal or capture an audio signal as a digital audio data stream. The operating system may provide a shared buffer to act as a shared buffer, or pin, between the operating system and the audio interaction device. The application may provide audio buffers to the operating system. The operating system may mix audio buffers from one or more applications together for consumption by that audio interaction device. The operating system may then load the mixed audio buffer into a shared buffer with a portion of the mixed audio data stream for retrieval by the audio interaction device. Additionally, the audio interaction device may load the shared buffer with captured audio for retrieval by the operating system. The operating system may then forward the audio data streams to the appropriate applications.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to a shared buffer acting as audio communication channel for an audio interaction device reconfigured to allow channel sharing between audio data streams. An audio interaction device may execute a conversion between an initial audio data stream and an audio signal audibly detectable by a user. A shared buffer may act as an audio communication channel between an operating system and the audio interaction device. The digital audio system may execute an initial audio application with the operating system to process the initial audio data stream. The digital audio system may load the initial audio data stream into the shared buffer. The digital audio system may alter the audio communication channel into a restructured audio communication channel for a subsequent audio data stream while maintaining the initial audio data stream. The digital audio system may load the initial audio data stream into the restructured audio communication channel.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a computing device.

FIG. 2 illustrates, in a block diagram, one example of a digital audio system architecture.

FIG. 3 illustrates, in a flowchart, one example of a method for processing an audio data stream with an audio application.

FIG. 4 illustrates, in a flowchart, one example of a method for configuring an audio communication channel for an audio interaction device with the operating system.

FIG. 5 illustrates, in a flowchart, one example of a method for rendering or capturing an audio signal with the audio interaction device.

FIG. 6 illustrates, in a flowchart, one example of a method for adding a subsequent audio data stream to an audio communication channel with the operating system.

FIG. 7 illustrates, in a flowchart, one example of a method for altering an audio communication channel to load the subsequent audio data stream with the operating system.

FIG. 8 illustrates, in a flowchart, one example of a method for opening an audio data stream with the operating system.

FIG. 9 illustrates, in a flowchart, one example of a method for swapping the initial audio data stream for the subsequent audio data stream with the operating system.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a digital audio system.

When an operating system plays a sound out of or records audio from an audio interaction device, the operating system may open a shared buffer with the audio interaction device. In addition to the shared buffer, the operating system may use an event from a driver to identify when to read or write from the shared buffer.

The buffer size of the shared buffer may determine the latency of the audio data stream being played or recorded and the overall power consumption of digital audio system. The latency describes the delay inherent in the system performance. For a smaller buffer size, the latency may be lower and more power may be consumed, and vice versa. Some operating systems may use a single buffer size, such as 10 ms, for a shared buffer with audio devices. This buffer size may put a lower bound on the latency of an audio application. Other operating systems may provide additional buffer sizes for lower power but higher latency for audio playback scenarios.

Low latency scenarios may have smaller shared buffers for the audio interaction device. Lower latency may have a negative impact on battery life of mobile devices. The operating system may open regular buffers for most audio situations and switch to smaller buffer sizes for specific use cases. The operating system may open different buffer sizes depending on the use case that the user is engaged in, in a manner so that the operating system may support applications with differing latency specifications concurrently. The operating system may store a stream state for the different audio data streams while adjusting the shared buffers to meet different audio data stream specifications to prevent any degradation to the audio data streams.

Thus, in one example, a shared buffer acting as an audio communication channel for an audio interaction device may be reconfigured to allow channel sharing between audio data streams. An audio interaction device may execute a conversion between an initial audio data stream and an audio signal audibly detectable by a user. A shared buffer may act as an audio communication channel between an operating system and the audio interaction device. The digital audio system may execute an initial audio application with the operating system to process the initial audio data stream. The digital audio system may load the initial audio data stream into the shared buffer. The digital audio system may alter the audio communication channel into a restructured audio communication channel for a subsequent audio data stream while maintaining the initial audio data stream. The digital audio system may load the initial audio data stream into the restructured audio communication channel.

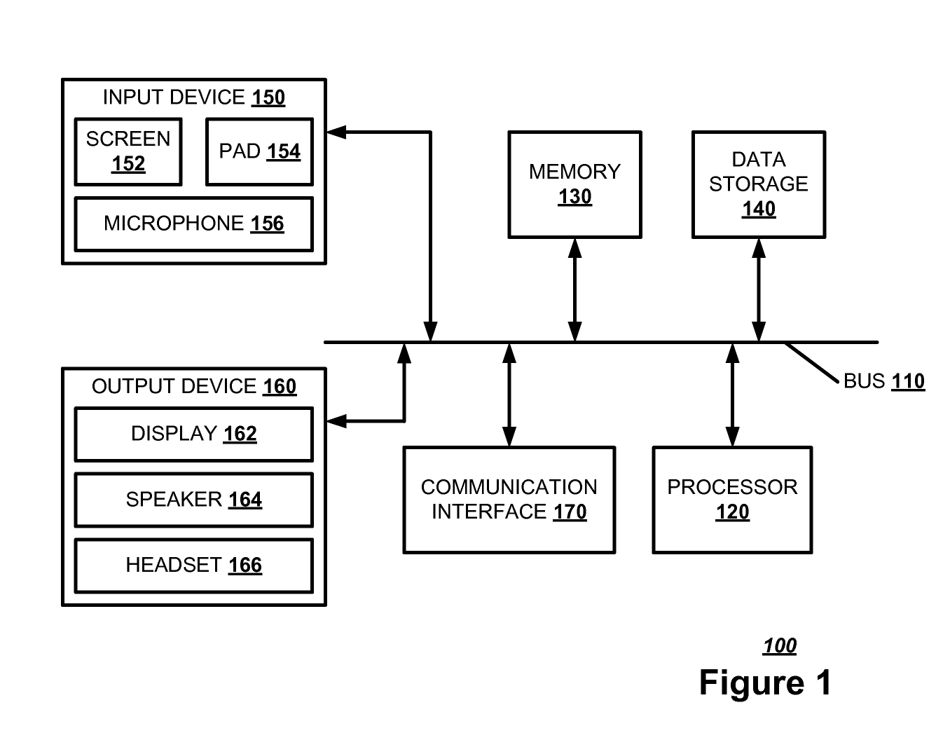

FIG. 1 illustrates a block diagram of an exemplary computing device 100 which may act as a digital audio system. The computing device 100 may combine one or more of hardware, software, firmware, and system-on-a-chip technology to implement a digital audio system. The computing device 100 may include a bus 110, a processing core 120, a memory 130, a data storage 140, an input device 150, an output device 160, and a communication interface 170. The bus 110, or other component interconnection, may permit communication among the components of the computing device 100.

The processing core 120 may include at least one conventional processor or microprocessor that interprets and executes a set of instructions. The processing core 120 may execute an initial audio application with an operating system to process an initial audio data stream. The operating system may load the initial audio data stream into the shared buffer. The operating system may alter the audio communication channel into a restructured audio communication channel for a subsequent audio data stream while maintaining the initial audio data stream. The operating system may load the initial audio data stream into the restructured audio communication channel. The operating system may determine whether the audio interaction device has multiple audio communication channels available. The operating system may receive a stream specification describing at least one of a latency specification and a data format for the subsequent audio data stream from a subsequent audio application. The operating system may identify a stream type for the subsequent audio data stream based on at least one of a stream characteristic and an application characteristic. The operating system may alter the audio communication channel by resizing the shared buffer acting as the audio communication channel. The operating system may alter the audio communication channel by changing a data format accepted by the audio communication channel. The operating system may apply a stream converter to convert the initial audio data stream for use by the restructured audio communication channel.

The memory 130 may be a random access memory (RAM) or another type of dynamic data storage that stores information and instructions for execution by the processor 120. The memory 130 may also store temporary variables or other intermediate information used during execution of instructions by the processor 120. The memory 130 may store an operating system to execute an initial audio application. The memory 130 may apportion a shared buffer to the operating system and the audio interaction device configured to act as an audio communication channel between the operating system and the audio interaction device. The memory 130 may apportion to the operating system an operating system stack configured to retain a stream state describing a state of the initial audio data stream while altering the audio communication channel.

The data storage 140 may include a conventional ROM device or another type of static data storage that stores static information and instructions for the processor 120. The data storage 140 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 140 may store a set of instructions detailing a method that when executed by one or more processors cause the one or more processors to perform the method. The data storage 140 may also be a database or a database interface for storing audio data.

The input device 150 may include one or more conventional mechanisms that permit a user to input information to the computing device 100, such as a keyboard, a mouse, a touch screen 152, a touch pad 154, a gesture recognition device, a voice recognition device, a microphone 156, a headset, etc. The input device 150 may be an audio interaction device to capture an audio signal as a digital audio data stream. The output device 160 may include one or more conventional mechanisms that output information to the user, including a display screen 162, a printer, one or more speakers 164, a headset 166, a vibrator, or a medium, such as a memory, or a magnetic or optical disk and a corresponding disk drive. The output device 160 may be an audio interaction device to render a digital audio data stream as an audio signal audible to a user.

The communication interface 170 may include any transceiver-like mechanism that enables computing device 100 to communicate with other devices or networks. The communication interface 170 may include a network interface or a transceiver interface. The communication interface 170 may be a wireless, wired, or optical interface.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the data storage 140, or from a separate device via the communication interface 160.

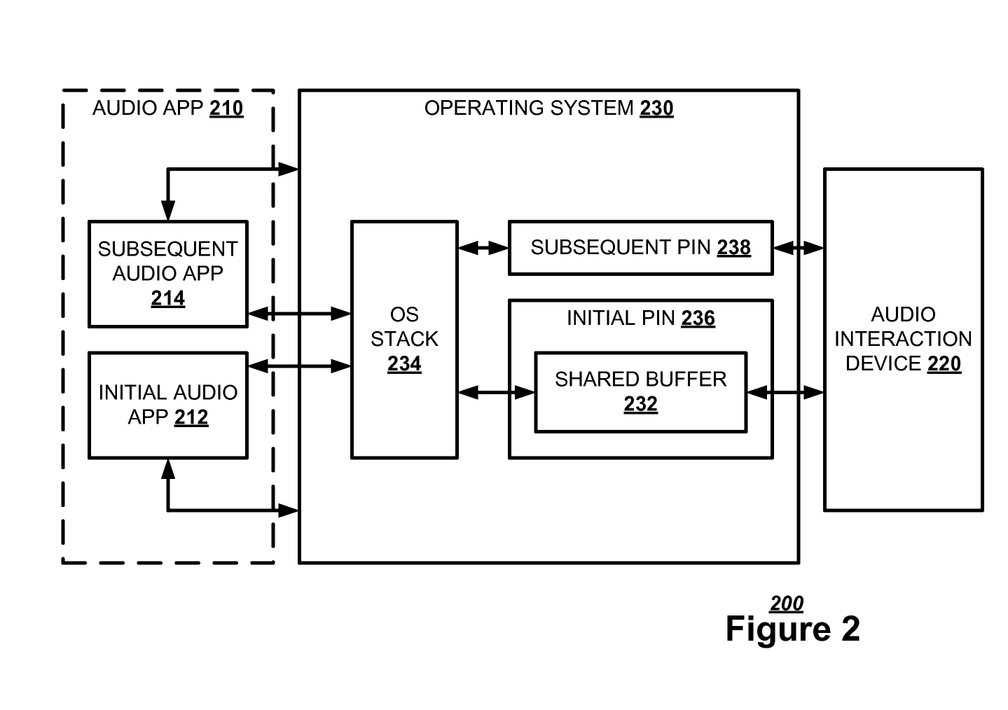

FIG. 2 illustrates, in a block diagram, one example of a digital audio system architecture 200. The digital audio system 200 may have an audio application 210 that processes an audio data stream for an audio interaction device 220. The audio application 210 is an application that either produces an audio data stream from a data file for rendering or processes a captured audio data stream for storage or transmission. The audio interaction device 220 is a device configured to execute a conversion between the audio data stream and an audio signal audibly detectable by a user, such as a speaker 164 or a headset 166, or converts between a captured audio signal and an audio data stream, such as a microphone 156.

An operating system 230 may transport the audio data stream from the audio application 210 to the audio interaction device 220. The operating system 230 may maintain a shared buffer 232 that acts as an audio communication channel, or pin between the operating system 230 and the audio interaction device 220. The operating system 230 may receive the audio data stream in an operating system stack 234 for storage in the shared buffer 232. The audio application 210 may provide a first portion of the audio data stream to the operating system for storage in the shared buffer 232. Once the audio interaction device 220 has retrieved the stored portion of the audio data stream in the shared buffer 232, the operating system may request the next portion of the audio data stream from the audio application 210. The operating system 230 may continue this exercise until the audio data stream is exhausted. Alternately, the operating system 230 may provide captured audio data from the audio interaction device 220 to the audio application as an audio data stream to the audio application, using the same buffered process.

Multiple audio applications 210 may use the same audio interaction device 220. Each audio application 210 may have one or more audio data streams presented to the audio interaction device 220 by the operating system via the separate audio communication channels or the same audio communication channel. An initial audio application 212 may process an initial audio data stream exchanged with the audio interaction device 220 via an initial audio communication channel 236, while a subsequent audio application 214 may process a subsequent audio data stream exchanged with the audio interaction device 220 via a subsequent audio communication channel 238. Alternately, the same application may process both the initial audio data stream and the subsequent audio data stream. Further, the initial audio data stream and the subsequent audio data stream may both be exchanged with the audio interaction device 220 via the initial audio communication channel 236. The initial audio communication channel 236 and the subsequent audio communication channel 238 may each be a shared buffer with a different configuration. The configuration of the shared buffer 232 may describe the buffer size and the format of the data stored in the buffer.

The buffer size may be described in the length of the audio data stream stored in the shared buffer 232 when in the buffer format. Generally, a shorter buffer size may result in lower latency and greater power consumption. For example, a 10 ms buffer size may result in a latency of a 10 ms delay in the audio signal, while a 100 ms buffer size may result in a latency of a 100 ms delay in the audio signal. While some operating systems 230 may have a standardized buffer size, other operating systems 230 may adjust the buffer size based on the power consumption profile of the computing device or on the latency specification of the audio data stream being stored. Certain audio applications may have a high latency specification, such as a recorded music playback, while other audio applications may have a low latency specification, such as a real-time musical performance application. Generally, if an initial audio data stream and a subsequent audio data stream are sharing an audio communication channel for the audio interaction device 220, the shared buffer 232 may be configured to the lower latency specification of the two audio data streams.

When the initial audio data stream and the subsequent audio data stream are sharing the initial audio communication channel 236, the operating system 230 may pause the initial audio data stream to reconfigure the initial audio communication channel 236 based on a stream specification of the subsequent audio data stream if incompatible. The stream specification may describe the latency specification and the data format for an audio data stream. The operating system 230 may select the data format for the shared buffer 232 based on ease of conversion. For example, if the operating system 230 may easily convert the initial audio data stream to the data format of the subsequent audio data stream, the shared buffer 232 may have the subsequent data format. Alternately, if the operating system 230 may easily convert the subsequent audio data stream to the data format of the initial audio data stream, the shared buffer 232 may have the initial data format.

The operating system 230 may pause the initial audio data stream to alter the buffer size of the shared buffer 232, alter the data format of the shared buffer 232, or to replace the initial audio data stream with the subsequent audio data stream, such as when a music playback is interrupted by a telephone call. The operating system stack 234 may retain the stream state for the initial audio data stream while paused. The stream state describes the state of the audio data stream, such as stream position or signal processing state. By retaining the stream state, the operating system 234 may more effectively restart transmission of the initial audio data stream to the audio interaction device 220 at the appropriate time.

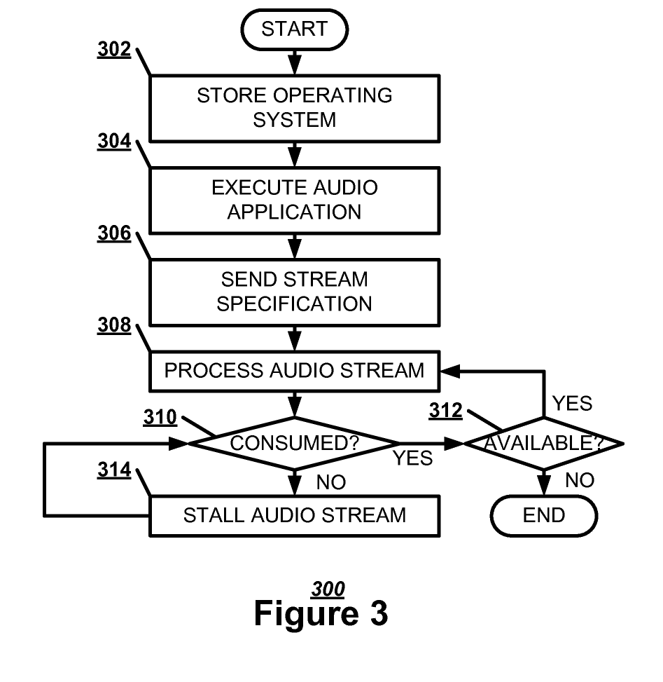

FIG. 3 illustrates, in a flowchart, one example of a method 300 for producing an audio data stream with an audio application. The memory of a computing device, such as computing device 100, may store an operating system, such as operating system 230, to execute an initial application (Block 302). The processor of a computing device may execute the initial audio application via the operating system to process an initial audio data stream (Block 304). The audio application may send a stream specification to the operating system (Block 306). The audio application may process an audio data stream stored in a shared buffer of the operating system acting as an audio communication channel between the operating system and an audio interaction device, such as audio interaction device 220 (Block 308). If the audio interaction device or the audio application has consumed the portion of the audio data stream stored in shared buffer (Block 310), and more audio data stream is available (Block 312), the audio application may process more audio data stream stored in the shared buffer (Block 308). If the audio interaction device has not consumed the portion of the audio data stream stored in shared buffer or produced more audio data stream for the shared buffer (Block 310), the audio application may be stalled from processing more audio data stream stored in the shared buffer (Block 314).

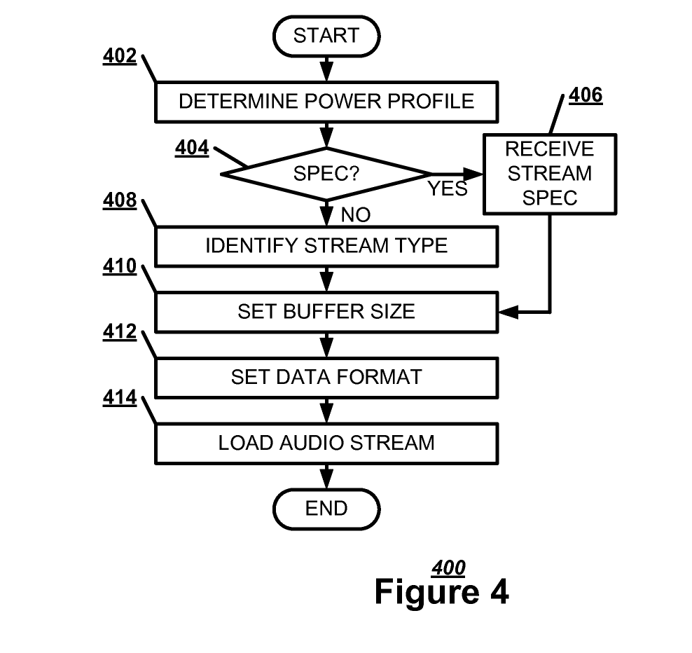

FIG. 4 illustrates, in a flowchart, one example of a method 400 for configuring an audio communication channel for the audio interaction device with the operating system. The operating system may determine a power consumption profile for the computing device acting as a digital audio system (Block 402). If an initial audio application has provided a stream specification for the initial audio data stream being produced (Block 404), the operating system may receive the stream specification for the initial audio data stream from the initial audio application (Block 406). Otherwise, the operating system may identify a stream type for the initial audio data stream based on stream and application characteristics (Block 408). The operating system may set a buffer size for the shared buffer acting as an audio communication channel (Block 410). The operating system may set a data format for the shared buffer acting as the audio communication channel (Block 412). The operating system may load at least the initial audio data stream in the shared buffer from either the initial audio application or the audio interaction device (Block 414).

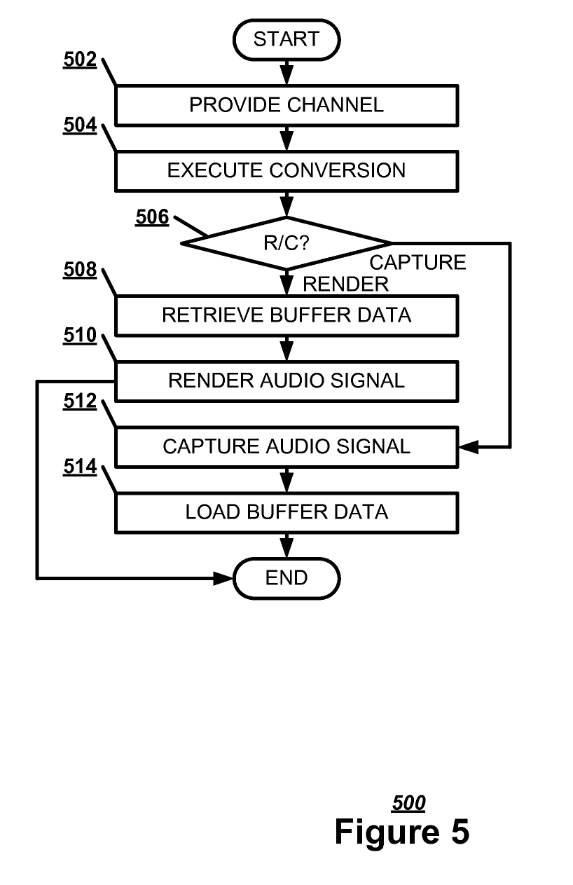

FIG. 5 illustrates, in a flowchart, one example of a method 500 for rendering an audio signal with the audio interaction device. The audio interaction device may provide an audio communication channel to the operating system to identify a shared buffer on the operating system that the audio interaction device may access to retrieve an audio data stream (Block 502). The audio interaction device may execute a conversion between the initial audio data stream and an audio signal audibly detectable by a user (Block 504). If the audio interaction device is in a render mode (Block 506), the audio interaction device may retrieve a set of buffer data stored in the shared buffer of the operating system (Block 508). The audio interaction device may render the buffer data into an audio signal presented to a user (Block 510). If the audio interaction device is in a capture mode (Block 506), the audio interaction device may capture an audio signal as a set of buffer data (Block 512). The audio interaction device may load at least the captured set of buffer data into the shared buffer of the operating system (Block 514).

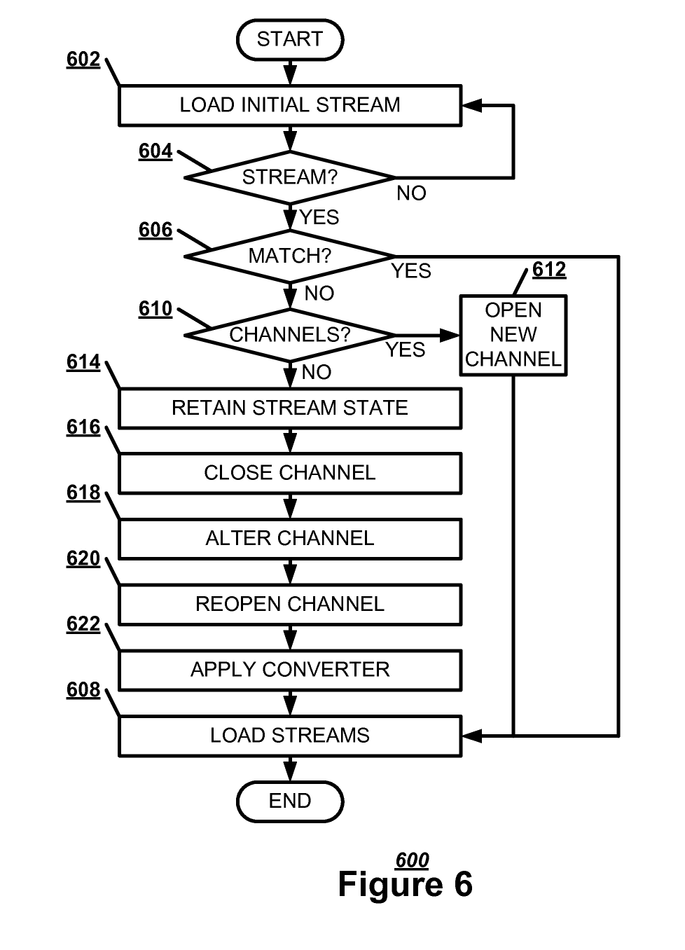

FIG. 6 illustrates, in a flowchart, one example of a method 600 for adding a subsequent audio data stream with the operating system. The operating system may load an initial audio data stream from either an initial audio application or an audio interaction device into a shared buffer acting as an audio communication channel between the operating system and the audio interaction device that executes a conversion between the initial audio data stream and an audio signal audibly detectable by a user (Block 602). If a subsequent audio application seeks to interact with the audio interaction device via a subsequent audio data stream (Block 604), and the operating system determines that the stream specification of the subsequent audio data stream matches the stream specification of the initial audio data stream (Block 606), the operating system may load the initial audio data stream and the subsequent audio data stream in the same audio communication channel (Block 608). If the operating system determines that the stream specification of the subsequent audio data stream does not match the stream specification of the initial audio data stream (Block 606), and the operating system determines that the audio interaction device has multiple audio communication channels available (Block 610), the operating system may open a new audio communication channel on the audio interaction device (Block 612). The operating system may load the initial audio data stream on the initial audio communication channel and the subsequent audio data stream on the subsequent audio communication channel (Block 608). Otherwise, the operating system may retain a stream state describing a state of the initial audio data stream in an operating system stack while altering the audio communication channel for the subsequent audio data stream (Block 614). The operating system may close the audio communication channel to the initial audio data stream (Block 616). The operating system may alter the audio communication channel into a restructured audio communication channel for the subsequent audio data stream while maintaining the initial audio data stream (Block 618). The operating system may reopen the audio communication channel to the initial audio data stream (Block 620). The operating system may apply a stream converter to convert the initial audio data stream for use by the restructured audio communication channel (Block 622). The operating system may load the initial audio data stream and the subsequent audio data stream into the restructured audio communication channel (Block 608).

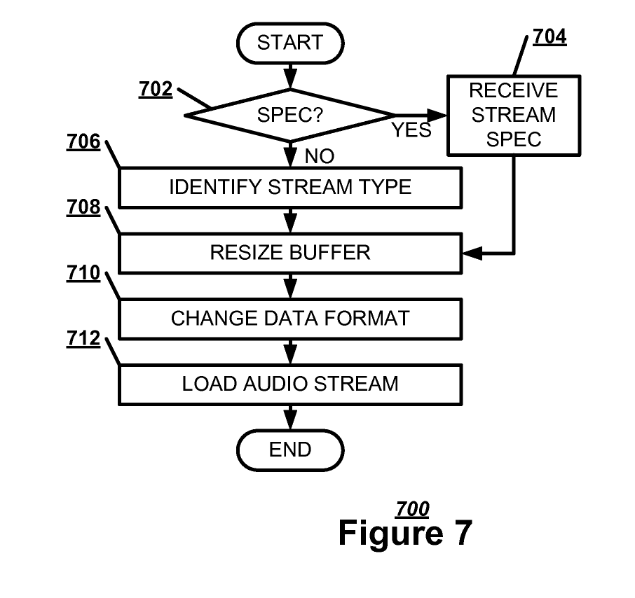

FIG. 7 illustrates, in a flowchart, one example of a method 700 for altering an audio communication channel for the subsequent audio data stream with the operating system. If a subsequent audio application has provided a stream specification for the subsequent audio data stream being produced (Block 702), the operating system may receive the stream specification describing at least one of a latency specification and a data format for the subsequent audio data stream from the subsequent audio application (Block 704). Otherwise, the operating system may identify a stream type for the subsequent audio data stream from the subsequent audio application based on at least one of a stream characteristic and an application characteristic (Block 706). The operating system may resize the shared buffer acting as an audio communication channel based on at least one of a latency specification of a subsequent audio data stream and a power consumption profile of the digital audio system (Block 708). The operating system may change the data format accepted by the audio communication channel (Block 710). The operating system may load the initial audio data stream and the subsequent audio data stream in the shared buffer (Block 712).

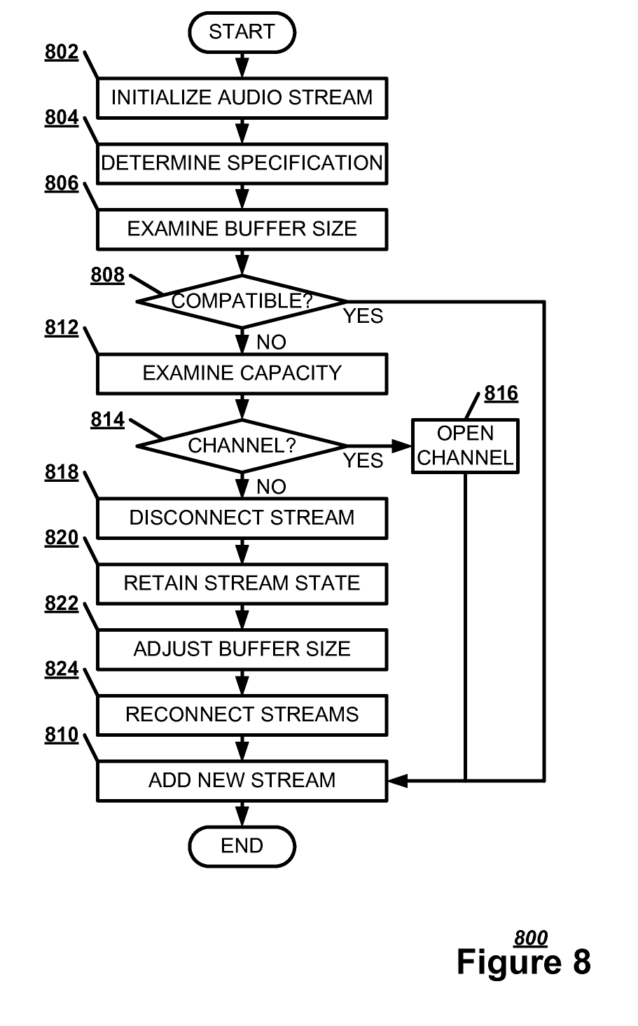

FIG. 8 illustrates, in a flowchart, one example of an integrated method 800 for opening an audio data stream with the operating system. The operating system may initialize the initial audio data stream using a set of initial audio data stream parameters (Block 802). The operating system may determine the latency specifications and power consumption profile for the digital audio system based on the set of initial audio data stream parameters (Block 804). The operating system stack may examine the shared buffer size for the digital audio system to determine whether the current buffer size may accommodate the subsequent audio data stream (Block 806). If the current configuration is compatible with adding a new audio data stream (Block 808), the operating system may add the subsequent audio data stream to the same audio communication channel (Block 810). If the current configuration is not compatible with adding a new audio data stream (Block 808), the operating system may examine the audio communication channel capacity of the audio interaction device to determine if a new audio communication channel may be opened with the requested buffer size (Block 812). If audio interaction device has an available audio communication channel (Block 814), the operating system may open a new audio communication channel on the audio interaction device with the requested buffer size (Block 816). Otherwise, the operating system may disconnect the existing audio data streams from the open audio communication channel (Block 818). The operating system may retain a stream state for the existing audio data streams while altering the audio communication channel for the subsequent audio data stream (Block 820). The operating system may close the audio communication channel from under the running streams and reopen the audio communication channel with a buffer size that meets the specifications of the new audio data streams and the existing audio data streams (Block 822). The operating system may reconnect the existing streams to the reopened audio communication channel (Block 824). The operating system may add the new stream on the reopened audio communication channel (Block 810).

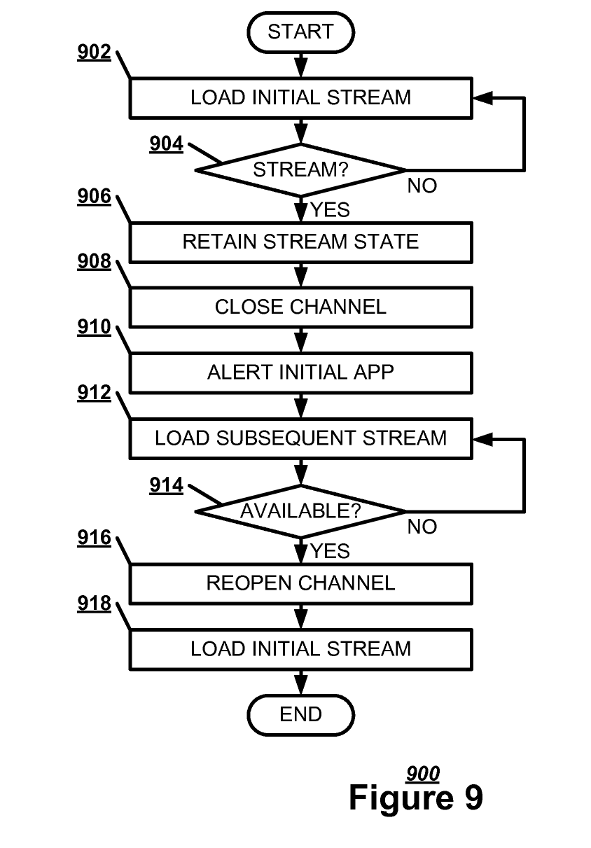

The operating system may also pause an initial audio data stream to allow a subsequent audio data stream to interrupt the initial audio data stream, such as for a reapplication constrained digital audio system. FIG. 9 illustrates, in a flowchart, one example of a method 900 for swapping the subsequent audio data stream for the initial audio data stream with the operating system. The operating system may load the initial audio data stream from either the initial audio application or the audio interaction device into the shared buffer acting as the audio communication channel between the operating system and the audio interaction device (Block 902). If a subsequent audio application seeks to interrupt the interaction of the initial audio application and the audio interaction device (Block 904), the operating system may retain a stream state for the initial audio data stream while altering the audio communication channel for the subsequent audio data stream (Block 906). The operating system may close the audio communication channel to the initial audio data stream (Block 908). The operating system may alert the initial audio application that the audio communication channel is closed (Block 910). The operating system may load the subsequent audio data stream into the audio communication channel (Block 912). If more of the subsequent audio data stream is available (Block 914), the operating system may load the subsequent audio data stream into the audio communication channel (Block 912). Once the subsequent audio data stream is completed (Block 914), the operating system may open the audio communication channel to the initial audio data stream (Block 916). The operating system may load the initial audio data stream into the audio communication channel (Block 918).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A digital audio system, comprising:
an audio interaction device configured to execute a conversion between an initial audio data stream and an audio signal audibly detectable by a user;
a shared buffer configured to act as an audio communication channel between an operating system and the audio interaction device; and
a processing core having at least one processor configured to execute an initial audio application with the operating system to process the initial audio data stream, to load the initial audio data stream into the shared buffer, to alter the audio communication channel into a restructured audio communication channel for a subsequent audio data stream while maintaining the initial audio data stream, and to load the initial audio data stream into the restructured audio communication channel.

2. The digital audio system of claim 1, wherein the operating system is configured to alter the audio communication channel by resizing the shared buffer acting as the audio communication channel.

3. The digital audio system of claim 1, wherein the operating system is configured to alter the audio communication channel by changing a data format accepted by the audio communication channel.

4. The digital audio system of claim 1, wherein the operating system is configured to determine whether the audio interaction device has multiple audio communication channels available.

5. The digital audio system of claim 1, further comprising:
an operating system stack configured to retain a stream state describing a state of the initial audio data stream while altering the audio communication channel.

6. The digital audio system of claim 1, wherein the operating system is configured to receive a stream specification describing at least one of a latency specification and a data format for the subsequent audio data stream from a subsequent audio application.

7. The digital audio system of claim 1, wherein the operating system is configured to identify a stream type for the subsequent audio data stream based on at least one of a stream characteristic and an application characteristic.

8. The digital audio system of claim 1, wherein the operating system is configured to apply a stream converter to convert the initial audio data stream for use by the restructured audio communication channel.

9. A computing device, having a memory to store an operating system to execute an initial audio application, the computing device configured to load an initial audio data stream into a shared buffer acting as an audio communication channel between the operating system and an audio interaction device that executes a conversion between the initial audio data stream and an audio signal audibly detectable by a user, the computing device further configured to retain a stream state describing a state of the initial audio data stream, and the computing device also configured to close the audio communication channel to the initial audio data stream.

10. The computing device of claim 9, wherein the computing device is further configured to resize the shared buffer acting as the audio communication channel.

11. The computing device of claim 9, wherein the computing device is further configured to change a data format accepted by the audio communication channel.

12. The computing device of claim 9, wherein the computing device is further configured to alert the initial audio application that the audio communication channel is closed.

13. The computing device of claim 9, wherein the computing device is further configured load a subsequent audio data stream from a subsequent audio application into the audio communication channel.

14. The computing device of claim 9, wherein the computing device is further configured to determine whether the audio interaction device has multiple audio communication channels available.

15. The computing device of claim 9, wherein the computing device is further configured to receive a stream specification describing at least one of a latency specification and a data format for a subsequent audio data stream from a subsequent audio application.

16. The computing device of claim 9, wherein the computing device is further configured to identify a stream type for a subsequent audio data stream based on at least one of a stream characteristic and an application characteristic.

17. The computing device of claim 9, wherein the computing device is further configured to alter the audio communication channel into a restructured audio communication channel for a subsequent audio data stream.

18. The computing device of claim 9, wherein the computing device is further configured to apply a stream converter to convert the initial audio data stream for use by the restructured audio communication channel.

19. A machine-implemented method, comprising:
executing, with an operating system, an initial audio application to process an initial audio data stream;
loading the initial audio data stream into a shared buffer acting as an audio communication channel between the operating system and an audio interaction device;
executing a conversion between the initial audio data stream and an audio signal audibly detectable by a user with the audio interaction device;
retaining a stream state describing a state of the initial audio data stream in an operating system stack.

20. The method of claim 19, further comprising:
resizing the shared buffer based on at least one of a latency specification of a subsequent audio data stream and a power consumption profile of the digital audio system.
